(19) United States
(12) Patent Application Publication
(10) Pub. No.: US 2014/0359449 A1
(43) Pub. Date: Dec. 4, 2014

(54) AUTOMATED GENERATION OF AUDIBLE FORM

(71) Applicant: Google Inc., Mountain View, CA (US)

(72) Inventor: Zoltan Stekkelpak, Sunnyvale, CA (US)

(73) Assignee: Google Inc., Mountain View, CA (US)

(21) Appl. No.: 13/627,832

(22) Filed: Sep. 26, 2012

(51) Int. Cl. G06F 3/16

(52) U.S. Cl. 715/727

(57) ABSTRACT

A method for generating an audible information request form, comprising, receiving web page data for a website, analyzing the web page data to determine attributes related to a user interactive web element of the website, generating an audible form comprising one or more audible information inquiries based on the user interactive web element and establishing a telephone connection with a phone device associated with a second user. In certain aspects, the method further comprises steps for prompting the second user by providing the one or more audible information inquiries to the phone device, receiving audible response information from the phone device, wherein the audible response information comprises one or more responses related to the one or more audible information inquiries; and generating a request form based on the one or more responses. Systems and computer-readable media are also provided.

### BACKGROUND

Many businesses have multiple contact channels (e.g., websites and phone numbers) by which they may receive inquires and business orders from prospective clients and customers. It is generally advantageous for the business to efficiently deal with every incoming phone request. Although automated phone systems can be implemented to manage phone calls received at times when a human representative is unavailable, the cost of such systems is often prohibitive for smaller business owners.

### SUMMARY

The disclosed subject matter relates to a computer-implemented method for receiving web page data for a website, analyzing the web page data to determine attributes related to a user interactive web element of the website, generating an audible form comprising one or more audible information inquiries based on the user interactive web element and establishing a telephone connection with a phone device associated with a second user. In certain aspects the computer-implemented method further comprises steps for prompting the second user by providing the one or more audible information inquiries to the phone device, receiving audible response information from the phone device, wherein the audible response information comprises one or more responses related to the one or more audible information inquiries and generating a request form based on the one or more responses.

The disclosed subject matter also relates to a system for generating an audible information request form, the system comprising one or more processors and a computer-readable medium comprising instructions stored thereon, which when executed by the processors, cause the processors to perform operations comprising, receiving web page data for a website, analyzing the website to determine attributes related to a user interactive web element of the website, generating an audible form comprising one or more audible information inquiries based on the user interactive web element, storing the audible form on a memory device and establishing a telephone connection with a phone device associated with a second user. In certain aspects, the processors are further configured to perform operations for prompting the second user by providing the one or more audible information inquiries to the phone device, receiving audible response information from the phone device, wherein the audible response information comprises one or more responses related to the one or more audible information inquiries and generating a request form based on the one or more responses.

The disclosed subject matter also relates to a computer-readable medium comprising instructions stored therein, which when executed by a processor, cause the processor to perform operations comprising, receiving, using one or more computing devices, web page data for a website, analyzing, using one or more computing devices, the web page data to determine attributes related to a user interactive web element of the website, generating, using one or more computing devices, an audible form comprising one or more audible information inquiries based on the user interactive web element, wherein the audible form is based on a text-to-speech rendering of the user interactive web element and establishing a telephone connection with a phone device associated with a second user. In certain aspects, the computer-readable medium further comprises instructions for prompting the second user by providing the one or more audible information inquiries to the phone device, receiving audible response information from the phone device, wherein the audible response information comprises one or more responses related to the one or more audible information inquiries and generating a request form based on the one or more responses.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative, and not restrictive in nature.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the disclosed aspects. In the drawings:

FIG. 1 illustrates a flow diagram of an example method for generating and updating an audible form, according to certain aspects of the subject disclosure.

FIG. 2 illustrates a block diagram of an example system that can be used to implement some aspects of the subject technology.

FIG. 3 illustrates a flow diagram of an example method for receiving a telephone call from a second user and sending a request form to a web server, according to certain aspects of the subject disclosure.

FIG. 4 illustrates an example network that can be used to implement some aspects of the subject technology.

FIG. 5 illustrates an example electronic system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

Many businesses use multiple communication channels for the purpose of conducting business. For example, businesses can accept inquiries and/or orders for products or services via telephone, facsimile and/or a website, such as a business website. Some business websites that are configured to receive and forward customer orders are comprised of one or more user online forms that can be used accept information inputs from a user. Such forms are comprised of multiple user interactive web elements. As used herein, “user interactive web element” can encompass any web element(s) that can be used to receive information from a user. In some examples, user interactive web elements can include, but are not limited to, text fields, drop down menu(s), sliders, text entry fields, selection lists, radio buttons, etc., that may be used to prompt and receive information from a user. In the context of a business website, user interactive web elements may be used to receive inquiries or selections from a user, for example, regarding a question or order for a specific product or service. In certain aspects, user interactive web elements may form a form, such as an order form that appears on the business website to enable customers to place online orders. By way of example, a business website for a florist may have one or more web forms comprising multiple user interactive web elements, such as, a drop down menu for selecting a particular flower arrangement and a text entry field and text field for entering delivery address and/or payment information, etc. After a user completes the order by filling out the web forms, order information is then forwarded to the business, for example, in the form of a text-based request form. Request forms can be received using a variety of communication means including, but not limited to, email, text message or remote storage to one or more computers/servers that are accessible by the business.

Although business websites are usually available to receive/process orders or inquiries twenty-four hours per day, many customers still prefer to make inquiries/place orders via telephone. As such, larger businesses will often have twenty-four hour call centers and/or sophisticated automated answering services for handling after-hours telephone calls. However, due to cost considerations, small businesses often lack the means to provide twenty-four hour telephone support using call centers or automated call answering services. As such, smaller businesses are sometimes unable to receive and effectively process orders/inquiries during non-business hours.

In certain aspects, the present technology addresses the above needs by providing a method and system for analyzing a website (e.g., a business website) and generating an audible form that can be used to provide an automated telephone answering service. As used herein “audible form” can refer to audible information that represents written information, such as written prompts for user or order information. In certain aspects, an audible form can comprise audible inquiries based on a text-to-speech rendering of written information. As such, the audible form can be used to provide audible prompts that are presented in an order based on a layout of the user interactive elements, i.e., a user editable web form or order form. When presented with the audible form, a calling customer can speak responses to the audible inquiries. Subsequently, the user's spoken responses (e.g., audible response information) can be received and transcribed, for example, using speech-to-text rending to generate a request form. In certain implementations, the request form may correspond with a populated written request form that would have resulted had the user entered his/her responses into the user interactive elements (e.g., an online order form) of the business website.

Using the above example, if the florist website provided user interactive web elements (e.g., text entry fields) for receiving a delivery address from the user and subsequently provided selection menus for use in selecting a payment method, the resulting audible form may provide an audible inquiry asking a user to first speak the desired delivery address and to then speak a selection pertaining to a preferred payment method.

In certain implementations, the analysis of the web page can take into consideration certain attributes of the user interactive web elements when generating the audible form. As such, the audible form may be based at least in part on the context in which certain user interactive web elements are presented in the web page. By way of example, the manner in which new or unique interactive web elements are to be presented in the audible form can be based on the contextual attributes of the new or unique interactive web elements. In some implementations, after the audible form is created, the audible form will be manually editable, for example, by one or more users (such as a website owner or operator).

After the audible form has been generated and (optionally) edited by a website owner/operator, the audible form may be used to facilitate the generation of a request form. In practice, when an unanswerable telephone call is received by a business, the call can be forwarded to an online server, wherein the caller (e.g., a calling customer) can be presented with an audible form (e.g., in the form of a voice menu), comprising one or more audible information inquiries based on a website of the business. The audio information received by the customer in response to the audible information inquiries (e.g., “audible response information”) can be transcribed into a text-based output. In some examples, the transcribed audible response information can be formatted to produce a request form e.g., an order request or product inquiry.

The request form can then be stored for retrieval by the website owner and/or forwarded to the website owner (e.g., an agent of the business). Using the above example, a customer calling the florist during non-business hours would be presented with an audible form corresponding to an order form of the florist's website. The customer's spoken responses to the audible information inquiries of the audible form can be transcribed and stored as a written request form.

Delivery of the request form can be performed in a number of different ways. For example, the request form can be forwarded to a server hosting the business website, e.g., to be stored together with request forms received from the business website. Completed request forms can also be delivered to the business via emails, facsimile, etc. In some aspects, additional information can be appended to the request forms generated by the online server, for example, information indicating that a particular form was automatically generated by the online server.

II. Example Processes for Generating and Updating an Audible Form

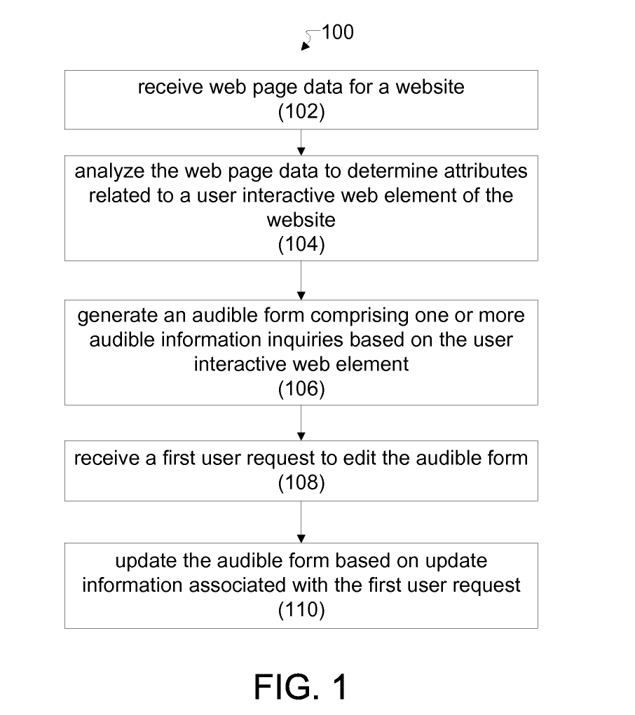

FIG. 1 illustrates a flow diagram of an example method 100 for generating and updating an audible form. The method 100 begins with block 102 in which web page data for a website is received, for example, by a computing device (such as a server), as will be described in further detail below. The web page data can comprise any information pertaining to the website including, but not limited to, one or more user interactive web elements (e.g., corresponding to a user “finable” form) of the website. As used herein, user interactive web elements can comprise any portion of a website that may be used to solicit and/or receive input from a user. By way of example, user interactive web elements can comprise, but are not limited to, text fields, checkboxes, radio-buttons, submit buttons, select lists and label elements, etc.

In block 104, the web page data is analyzed to determine attributes related to the one or more user interactive web elements of the web page. Attributes related to the user interactive web elements can comprise any information related to the user interactive web elements, including but not limited to, information pertaining to the context and placement of interactive web elements within the website. In some examples, the attributes can be used to determine the type of information/responses that the user interactive web elements are configured to elicit from a user.

In certain implementations, the analysis of web page data may involve a comparison of web page data with a database of known user interactive web elements. By way of example, the analysis of web page data for a florist website may comprise a comparison of one or more user interactive web elements of the florist website with a database of user interactive web elements that are known to correspond with web elements used on websites related to the general topic category of “florists” or “flowers,” etc.

In block 106, an audible form comprising one or more audible information inquires will be generated. The audible form can be based on one or more of the user interactive web elements of the website. For example, if a particular user interactive web element provides a text entry field for receiving address information from a user, the generated audible form may include one or more audible information inquiries corresponding to that particular user interactive web element. That is, one or more audible information inquiries will be generated that will prompt a calling user to provide spoken address information (e.g., audible response information).

After the audible form has been generated, the method 100 will proceed to block 108 in which a first user request to edit the audible form is received. In some implementations, the first user request to edit the audible form will be received by a computing device (e.g., a server) storing the audible form generated in block 106. The first user request to edit the audible form may be followed by control signals comprising edits, updates, changes, etc., to the audible form generated in block 106. In practice, the first user may be, for example, an owner or operator of the website (e.g. an agent of a business providing a business website).

In block 110, the audible form is updated based on information associated with the first user request. In some examples, updates and/or edits may be made by the first user to correct errors or inaccuracies in the generated audible form. In some implementations, the ability to edit/update the audible form will enable a website owner to customize the resulting audible form, before it is deployed for use in reception/processing of customer/client telephone calls, as will be described in further detail below.

III. Example System for Generating and Updating an Audible Form

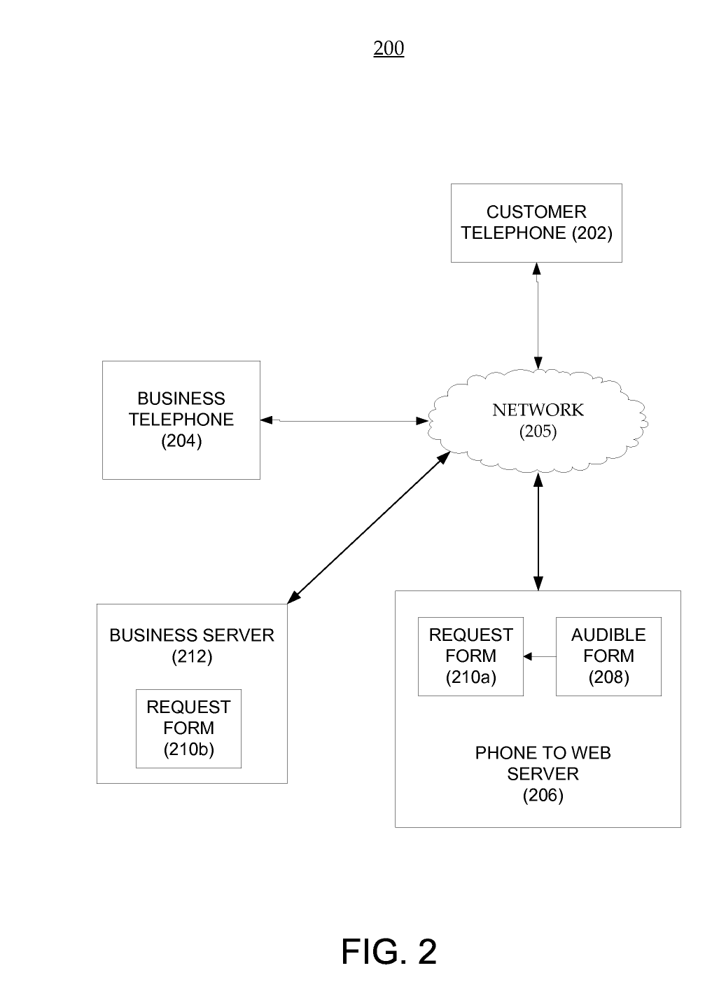

FIG. 2 illustrates a block diagram of an example system 200 that can be used to implement some aspects of the subject disclosure. Specifically, system 200 illustrates customer telephone 202, business telephone 204, phone-to-web server 206 and business server 212. As illustrated, phone to web server 206 comprises audible form 208 and a server copy of request form 210a. In the example illustrated, business server 212 comprises a business copy of request form 210b.

In some implementations, customer telephone 202, business telephone 204, phone to web server 206 and business server 212 will be communicatively connected via network 205. Network 205 can comprise any type of communications network(s), such as a public switched telephone network (PSTN), a wireless network, a private branch exchange (PBX) or a computer network, such as the Internet.

In practice, business telephone 204 will receive a telephone from customer telephone 202, via network 205. If a live operator (e.g., an employee of the business) is unable to answer the telephone call, the telephone call is forwarded to phone-to-web server 206. At phone-to-web server 206, the caller can be presented with an audible voice menu comprising the audible form 208. As discussed above, audible form 208 can comprise a plurality of audible information inquiries for use in soliciting certain types of information from the calling customer/client. In some implementations, the audible information inquiries of the audible from may be configured to solicit the same types of information that are solicited by a website of the business e.g., on an order form or inquiry form provided on the business's website.

Customer responses to the audible information inquires (e.g., audible response information) can then be transcribed and formatted to generate a request form, such as request form 210a. In certain implementations, request form 210a is formatted to resemble an order form that would have been produced had the customer completed one or more of the inquiry/order forms on the website. In certain aspects, the generated request form may also be augmented or appended with information indicating that request form 210 was generated and/or forwarded by phone-to web server 206. Subsequently, the business server copy of request form 210b is received by and/or stored on business server 212.

IV. Example Process for Populating a Request Form and Sending the Request Form to a Web Server

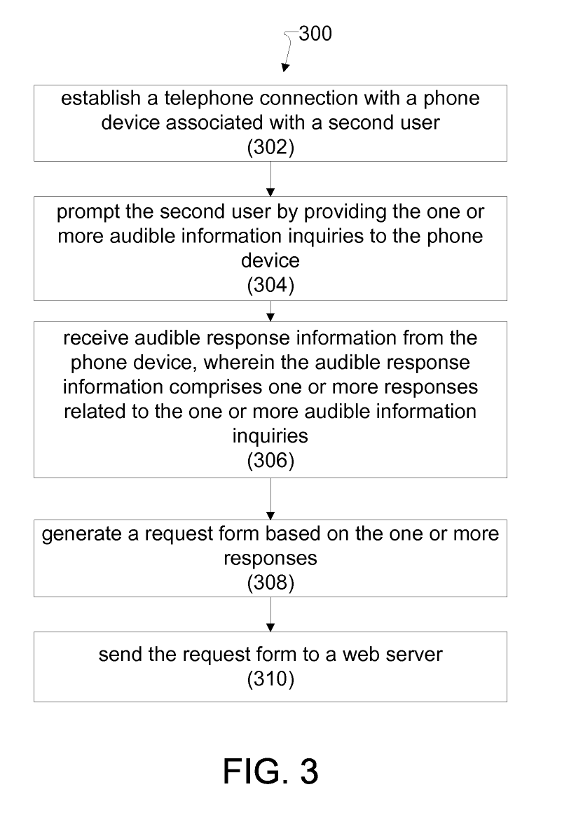

FIG. 3 illustrates a flow diagram of an example method 300 for receiving a telephone call from a second user and sending a request form to a web server. The method 300 begins with block 302 in which a telephone connection with a phone device associated with a second user is established. The second user can be any user whose telephone call is forwarded to an automated answering system and received by, for example, the phone-to-web server 206, described above.

In block 304, the second user is prompted with one or more audible information inquiries by providing the one or more audible information inquiries to the phone device associated with the second user. The audible information inquires can be presented to the user in the form of audible prompts or questions, for example, in the form of an audible menu or order form. In some implementations, the audible information inquires will solicit responses from the second user pertaining to the ordering of a particular good or service.

In block 306, audible response information (e.g., “audio information”) is received from the phone device, wherein the audio information comprises one or more responses related to the one or more audible information inquiries. In some examples, the one or more responses related to the one or more audible information inquiries will provide information related to the questions/prompts solicited by the audible information inquiries. Subsequently, in block 308, a request form is generated based on the audio information (e.g., the one or more responses) received in block 306. In some implementations, the audio information received from the second user is transcribed to produce a text-based request form. By way of example the request form can be formatted in a matter that corresponds with an order/inquiry form of a business.

In block 310, the request form is sent to a web server. Depending on the implementation, the web server may belong to a business and used to receive the request form for use in processing an order or information inquiry.

V. Example Network Systems for Facilitating the Generating and Updating of an Audible Form

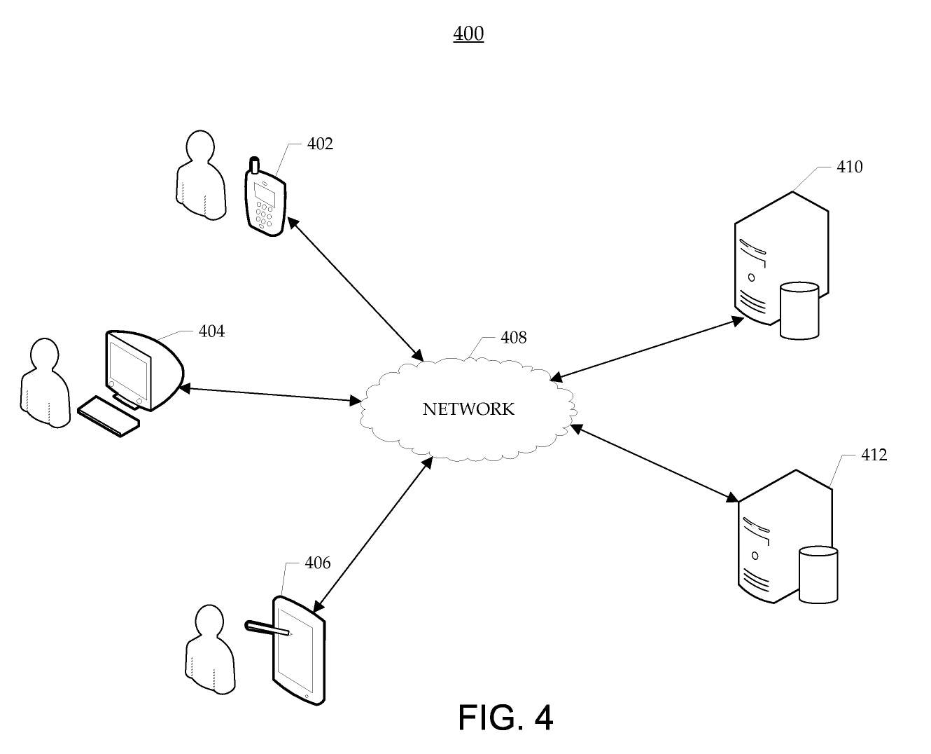

FIG. 4 illustrates an example network 400 that can be used to implement some aspects of the subject technology. Specifically, the network system 400 comprises user devices 402, 404 and 406, first server 410, second server 412 and network 408. As illustrated, user devices 402, 404 and 406, first server 410 and second server 412 are communicatively connected via network 408. It is understood that in addition to user devices 402, 404 and 406, first server 410 and second server 412, any number of processor-based devices could be communicatively connected to network 408. Furthermore, as discussed in greater detail below, network 408 can comprise multiple networks, such as a publicly operated telephone system, a wireless telephone network or a network of networks, e.g., the Internet.

In some examples, one or more of the process blocks of the subject technology can be carried out by one or more of user devices 402, 404 and 406, first server 410 and second server 412, over network 408. By way of example, first server 410 could host a website (e.g., a business website) on network 408. Furthermore, second server 412 could be configured to receive web page data for the website, e.g., via network 408 for use in analyzing the web page data to determine attributes related to one or more user interactive web elements of the website. The second server 412 may be further configured to generate an audible form comprising one or more audible information inquiries based on the user interactive web element.

In certain implementations, second server 412 could be further configured to receive a first user request to edit the audible form and update the audible form based on update information provided by the first user. In some examples, the first user request and update information may be sent via one of user devices 402, 404 and 406.

In other implementation, the second server could be configured to receive a telephone call from a second user (e.g., a call placed from user device 402), prompt the second user with the one or more audible information inquiries and receive audible response information from the second user, wherein the audible response information comprises one or more responses related to the one or more audible information inquiries and generating a request form based on the one or more responses. After the request form is generated, the second server may then send the request form to a web server (e.g., first server 410), via network 408.

VI. Example Systems for Facilitating the Generating and Updating of an Audible Form

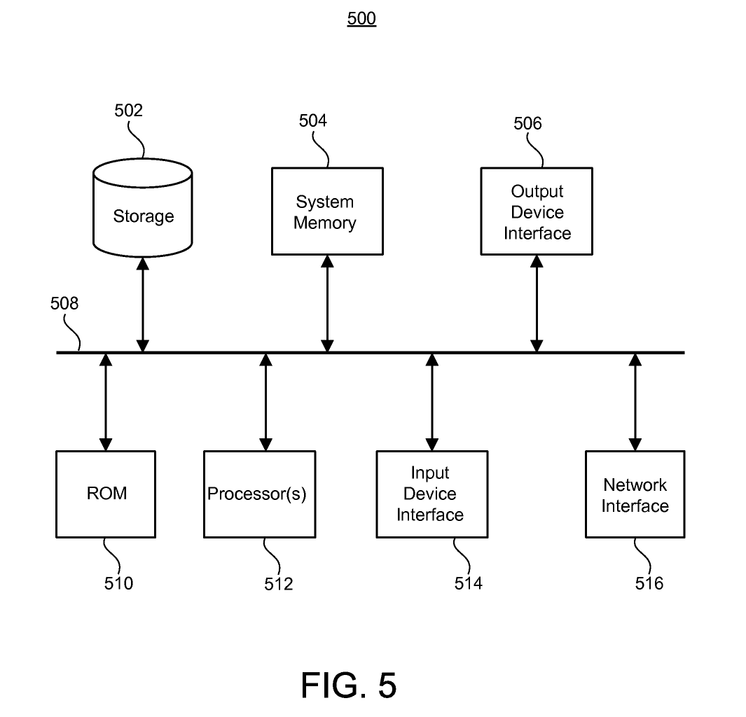

FIG. 5 illustrates an example of an electronic system that can be used for executing the steps of the subject disclosure. In some examples, processor-based system 500 can be a single computing device such as a server (e.g., the first server 410 and/or the second server 412, discussed above). Furthermore, in some implementations, processor-based system 500 can be operated alone or together with one or more other electronic systems e.g., as part of a cluster or a network of computers.

As illustrated, processor-based system 500 comprises storage 502, a system memory 504, an output device interface 506, system bus 508, ROM 510, one or more processor(s) 512, input device interface 514 and network interface 516. In some aspects, system bus 508 collectively represents all system, peripheral, and chipset buses that communicatively connect the numerous internal devices of processor-based system 500. For instance, system bus 508 communicatively connects the processor(s) 512 with ROM 510, system memory 504, output device interface 506 and permanent storage device 502.

In some implementations, processor(s) 512 retrieve instructions to execute (and data to process) in order to execute the steps of the subject technology. Processor(s) 512 can be a single processor or a multi-core processor in different implementations. Additionally, processor(s) can comprise one or more graphics processing units (GPUs) and/or one or more decoders, depending on implementation.

The ROM 510 stores static data and instructions that are needed by processor(s) 512 and other modules of processor-based system 500. Similarly, processor(s) 512 can comprise one or more memory locations such as CPU cache or processor in memory (PIM), etc. The storage device 502, is a read-and-write memory device. In some aspects, this device can be a non-volatile memory unit that stores instructions and data even when processor-based system 500 is without power. Some implementations of the subject disclosure can use a mass-storage device (such as solid state, magnetic or optical storage devices) e.g., permanent storage device 502.

Other implementations can use one or more a removable storage devices (e.g., magnetic or solid state drives) such as permanent storage device 502. Although the system memory can be either volatile or non-volatile, in some examples system memory 504 is a volatile read-and-write memory, such as a random access memory. System memory 504 can store some of the instructions and data that the processor needs at runtime.

In some implementations, the processes of the subject disclosure are stored in system memory 504, permanent storage device 502, ROM 510 and/or one or more memory locations embedded with the processor(s) 512. From these various memory units, processor(s) 512 retrieve instructions to execute and data to process in order to execute the processes of some implementations of the instant disclosure.

The bus 508 also connects to input device interface 514 and output device interface 506. The input device interface 514 enables a user to communicate information and select commands to processor-based system 500. Input devices used with the input device interface 514 may include for example, alphanumeric keyboards and pointing devices (also called “cursor control devices”) and/or wireless devices such as wireless keyboards, wireless pointing devices, etc.

Finally, as shown in FIG. 5, bus 508 also communicatively couples the processor-based system 500 to a network (not shown) through a network interface 516. It should be understood that network interface 516 can be either wired, optical or wireless and may comprise one or more antennas and transceivers. In this manner, processor-based system 500 can be a part of a network of computers, such as a local area network (“LAN”), a wide area network (“WAN”), or a network of networks, such as the Internet (e.g., network 408, as discussed above).

In practice, the methods of the subject technology can be carried out by processor-based system 500. In some aspects, instructions for performing one or more of the method steps of the present disclosure will be stored on one or more memory devices such as storage 502 and/or system memory 504.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include but are not limited to wired or wireless telephone networks, a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A method for generating an audible information request form, comprising:
receiving, using one or more computing devices, web page data for a website;
analyzing, using one or more computing devices, the web page data to determine attributes related to a user interactive web element of the website;
generating, using one or more computing devices, an audible form comprising one or more audible information inquiries based on the user interactive web element;
establishing, using one or more computing devices, a telephone connection with a phone device associated with a second user;
prompting, using one or more computing devices, the second user by providing the one or more audible information inquiries to the phone device;
receiving, using one or more computing devices, audible response information from the phone device, wherein the audible response information comprises one or more responses related to the one or more audible information inquiries; and
generating, using one or more computing devices, a request form based on the one or more responses.

2. The method of claim 1, wherein the audible form is based on a text-to-speech rendering of the user interactive web element.

3. The method of claim 1, wherein the one or more audible information inquiries are presented in an order based on the user interactive web element.

4. The method of claim 1, wherein generating the request form comprises:
performing a speech-to-text rendering of the one or more responses.

5. The method of claim 1, wherein generating the request form comprises:
formatting the request form based on a layout of the user interactive web element.

6. The method of claim 1, wherein the user interactive web element comprises at least one of a drop-down menu, a selection box, a text field, a radio button, a select list and a label element.

7. The method of claim 1, wherein analyzing the website to determine attributes related to the user interactive web element comprises:
comparing the user interactive web element to a database of known web elements.

8. The method of claim 1, wherein analyzing the website to determine attributes related to the user interactive web element comprises:
analyzing the user interactive web element based on the context in which the user interactive web element is presented on the website.

9. A system for generating an audible information request form, the system comprising:
one or more processors; and
a computer-readable medium comprising instructions stored thereon, which when executed by the processors, cause the processors to perform operations comprising:
receiving web page data for a website;
analyzing the website to determine attributes related to a user interactive web element of the website;
generating an audible form comprising one or more audible information inquiries based on the user interactive web element;
storing the audible form on a memory device;
establishing a telephone connection with a phone device associated with a second user;
prompting the second user by providing the one or more audible information inquiries to the phone device;
receiving audible response information from the phone device, wherein the audible response information comprises one or more responses related to the one or more audible information inquiries; and
generating a request form based on the one or more responses.

10. The system of claim 9, wherein the audible form is based on a text-to-speech rendering of the user interactive web element.

11. The system of claim 9, wherein the one or more audible information inquiries are presented in an order based on the user interactive web element.

12. The system of claim 9, wherein generating the request form comprises:
performing a speech-to-text rendering of the one or more responses.

13. The system of claim 9, wherein generating the request form comprises:
formatting the request form based on a layout of the user interactive web element.

14. The system of claim 9, wherein the user interactive web element comprises at least one of a drop-down menu, a selection box, a text field, a radio button, a select list and a label element.

15. The system of claim 9, wherein analyzing the website to determine attributes related to the user interactive web element comprises:
comparing the user interactive web element to a database of known web elements.

16. The system of claim 9, wherein analyzing the website to determine attributes related to the user interactive web element comprises:
analyzing the user interactive web element based on the context in which the user interactive web element is presented on the website.

17. A computer-readable medium comprising instructions stored therein, which when executed by a processor, cause the processor to perform operations comprising:
receiving, using one or more computing devices, web page data for a website;
analyzing, using one or more computing devices, the web page data to determine attributes related to a user interactive web element of the website;
generating, using one or more computing devices, an audible form comprising one or more audible information inquiries based on the user interactive web element, wherein the audible form is based on a text-to-speech rendering of the user interactive web element;
establishing a telephone connection with a phone device associated with a second user;
prompting the second user by providing the one or more audible information inquiries to the phone device;
receiving audible response information from the phone device, wherein the audible response information comprises one or more responses related to the one or more audible information inquiries; and
generating a request form based on the one or more responses.

18. The computer-readable medium of claim 17, wherein the one or more audible information inquiries are presented in an order based on the user interactive web element.

19. The computer-readable medium of claim 17, wherein generating the request form comprises:
performing a speech-to-text rendering of the one or more responses.

20. The computer-readable medium of claim 17, wherein generating the request form comprises:
formatting the request form based on a layout of the user interactive web element.
